(19) United States
(12) Patent Application Publication
(10) Pub. No.: US 2007/0150634 A1
(43) Pub. Date: Jun. 28, 2007

(54) Information processing apparatus and video signal amplitude control method

(75) Inventor: Hiroaki Chiba, Sagamihara-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/523,467

(22) Filed: Sep. 19, 2006

(30) Foreign Application Priority Data
Dec. 22, 2005 (JP) 2005-369560

(51) Int. Cl. G06F 13/00

(52) U.S. Cl. 710/303

(57) ABSTRACT

According to one embodiment of the invention, an information processing apparatus comprises a main body which is detachably connected to an external apparatus having a first video signal output terminal to which a display device is connectable, a second video signal output terminal provided on the main body, to which the display device is connectable, a detection unit provided in the main body, which detects whether the main body is connected to the external apparatus, and a display controller provided in the main body, which outputs a video signal having a first amplitude in a case where the main body is not connected to the external apparatus, and changes an amplitude of the video signal to a second amplitude which is greater than the first amplitude in a case where the main body is connected to the external apparatus.

### CROSS-REFERENCE TO RELATED APPLICATIONS

This application is based upon and claims the benefit of priority from Japanese Patent Application No. 2005-369560, filed Dec. 22, 2005, the entire contents of which are incorporated herein by reference.

### BACKGROUND

1. Field

One embodiment of the invention relates to an information processing apparatus such as a personal computer, for example, including a display controller for outputting a video signal and a method of controlling the amplitude of the video signal.

2. Description of the Related Art

In recent years, various display devices have been developed as display monitors of computers.

Jpn. Pat. Appln. KOKAI Publication No. 2001-339315 discloses a computer which outputs a video signal to a liquid crystal projector via a cable. This computer has a function of adjusting the amplitude of a video signal to be output, in accordance with a signal indicative of a reception level of a video signal, which is sent from the liquid crystal projector. By this feedback control, the amplitude of the video signal, which is output from the computer, can automatically be adjusted in accordance with the length of the cable.

Besides, in recent years, various types of portable computers, such as laptop computers and notebook computers, have been developed.

The main body of the portable computer has, in normal cases, a video signal output terminal for connection to a display device. In addition, in order to extend the functions of the portable computer, the portable computer can be connected, as needed, to an external apparatus such as a port replicator or a docking station. The external apparatus, too, has a video signal output terminal for connection to the display device.

Thus, when the portable computer is connected to the external apparatus, the display device, which is connected to the external apparatus, can be used as a display monitor of the portable computer.

In normal cases, however, the amplitude of a video signal, which is output from the display controller provided in the portable computer, has a fixed value.

Consequently, the amplitude value of a video signal, which appears at the video signal output terminal provided on the external apparatus, becomes less than the amplitude value of a video signal, which appears at the video signal output terminal provided on the main body of the portable computer. The reason is that in the case where a video signal from the display controller is output from the video signal output terminal provided on the external apparatus, the length of the wiring line for transmitting the video signal becomes relatively great and a DC resistance component due to the wiring line increases.

In usual cases, the amplitude value of the video signal at the video signal output terminal is set at, e.g. 700 mV ±5%, by technical standards.

However, if the amplitude value of the video signal, which appears at the video signal output terminal on the main body side of the portable computer, is made to conform to technical standards, the amplitude value of the video signal, which appears at the video signal output terminal on the external apparatus side, decreases and may fail to meet the standards. On the other hand, if the amplitude value of the video signal, which appears at the video signal output terminal on the external apparatus side, is made to conform to the technical standards, the amplitude value of the video signal, which appears at the video signal output terminal on main body side of the portable computer, increases and may fail to meet the standards.

Under the circumstances, it is necessary to realize a novel function which can easily output video signals with predetermined amplitudes conforming to technical standards to both the video signal output terminal on the external apparatus side and the video signal output terminal on the main body side of the portable computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the general appearance of a computer according to an embodiment of the invention;

FIG. 2 is an exemplary perspective view of the rear side of the computer shown in FIG. 1;

FIG. 3 is an exemplary view showing a state in which the computer shown in FIG. 1 is connected to an external apparatus;

FIG. 4 is an exemplary block diagram showing an example of the system configuration of the computer shown in FIG. 1;

FIG. 5 is an exemplary diagram showing an example of the structures of a GPU and its peripheral circuits provided in the computer shown in FIG. 1;

FIG. 6 is an exemplary diagram showing another example of the structures of the GPU and its peripheral circuits provided in the computer shown in FIG. 1; and

FIG. 7 is an exemplary flow chart illustrating an example of the procedure of a video signal amplitude switching process, which is executed by the computer shown in FIG. 1.

### DETAILED DESCRIPTION

Various embodiments according to the invention will be described hereinafter with reference to the accompanying drawings. In general, according to one embodiment of the invention, an information processing apparatus includes a main body which is detachably connected to an external apparatus having a first video signal output terminal to which a display device is connectable, a second video signal output terminal which is provided on the main body and to which the display device is connectable, a detection unit which is provided in the main body and detects whether the main body is connected to the external apparatus, and a display controller which is provided in the main body. The display controller outputs a video signal having a first amplitude in a case where the detection unit detects that the main body is not connected to the external apparatus, thereby to display image data on the display device which is connected to the second video signal output terminal, and changes an amplitude of the video signal to a second amplitude which is greater than the first amplitude in a case where the detection unit detects that the main body is connected to the external apparatus, thereby to display image data on the display device which is connected to the first video signal output terminal.

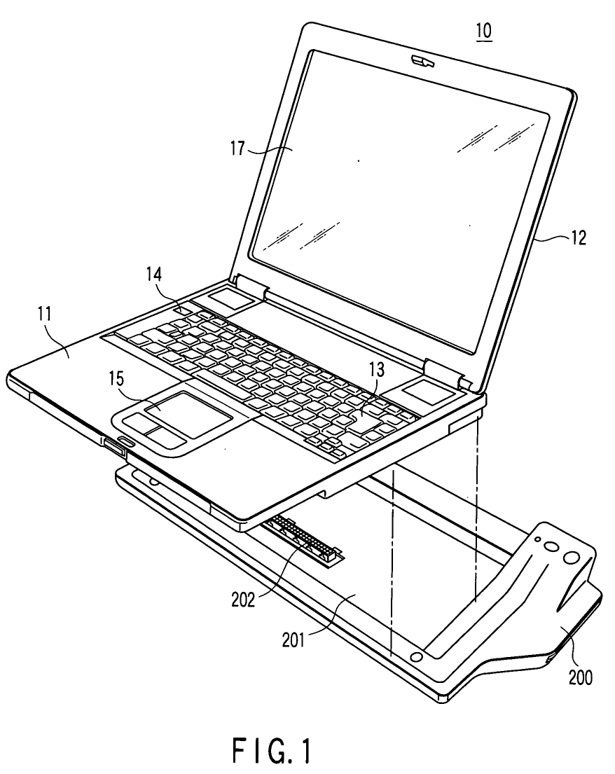

To begin with, the structure of an information processing apparatus according to an embodiment of the invention is described referring to FIG. 1 to FIG. 3. The information processing apparatus is realized, for example, as a battery-powerable notebook-type portable personal computer 10.

FIG. 1 is a perspective view showing the computer 10 in the state in which a display unit is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is supported on the computer main body 11 such that the display unit 12 is freely rotatable between an open position where the top surface of the computer main body 11 is exposed and a closed position where the top surface of the computer main body 11 is covered. The computer main body 11 has a thin box-shaped casing in which a battery is detachably mounted.

A keyboard 13, a power button switch 14 for powering on/off the computer 10, and a touch pad 15 are disposed on the top surface of the computer main body 11.

The computer 10 is configured to be detachably connected to an external apparatus 200. The external apparatus 200 includes a plurality of connectors for connection to various peripheral devices, and functions as an expansion unit for enhancing the functions of the computer 10. The expansion unit is usually called a docking station or a port replicator. The external apparatus 200 has a mount surface 201 for mounting of the computer main body 11. A docking connector 202 is provided on the mount surface 201. If the computer 10 is mounted on the external apparatus 200, a connector which is provided on the bottom surface of the computer main body 11 and is physically and electrically connected to the docking connector 202.

In a state (docking state) in which the computer 10 is connected to the external apparatus 200, the computer 10 is enabled to use various peripheral devices which are connected to the external apparatus 200.

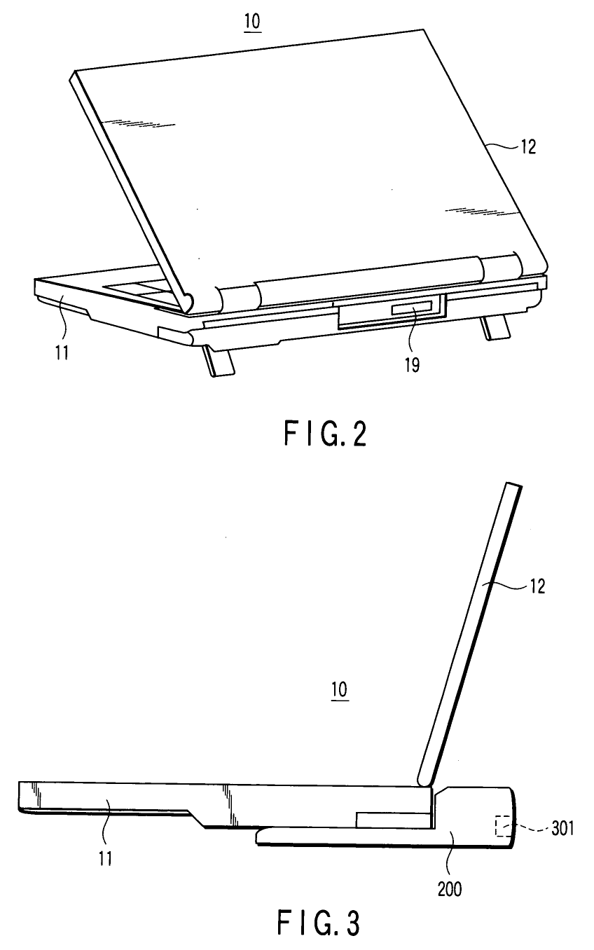

FIG. 2 is a rear-side view of the computer 10.

As shown in FIG. 2, a video signal output terminal 19, which functions as a connector for an external display, is provided on the rear surface of the computer main body 11. A display device is detachably connectable to the video signal output terminal 19. The display device is, for instance, a CRT display, a TV receiver, or a liquid crystal display with an interface according to the DVI (Digital Visual Interface) standard. By connecting the display device to the video signal output terminal 19 via any communication medium, such as a cable for example, the user can use the display as a display monitor of the computer 10.

FIG. 3 shows a state in which the computer main body 11 is connected to the external apparatus 200. As shown in FIG. 3, a video signal output terminal 301, which functions as a connector for an external display, is provided on the rear surface of the external apparatus 200. The display device, such as a CRT display, a TV receiver or a liquid crystal display with an interface according to the DVI (Digital Visual Interface) standard, is detachably connectable to the video signal output terminal 301.

In the state in which the computer main body 11 is connected to the external apparatus 200, the rear surface of the computer main body 11 is covered by the external apparatus 200. Consequently, the display device cannot be connected to the video signal output terminal 19 of the computer 10, but the computer 10 can output a video signal to the display device which is connected to the video signal output terminal 301 of the external apparatus 200.

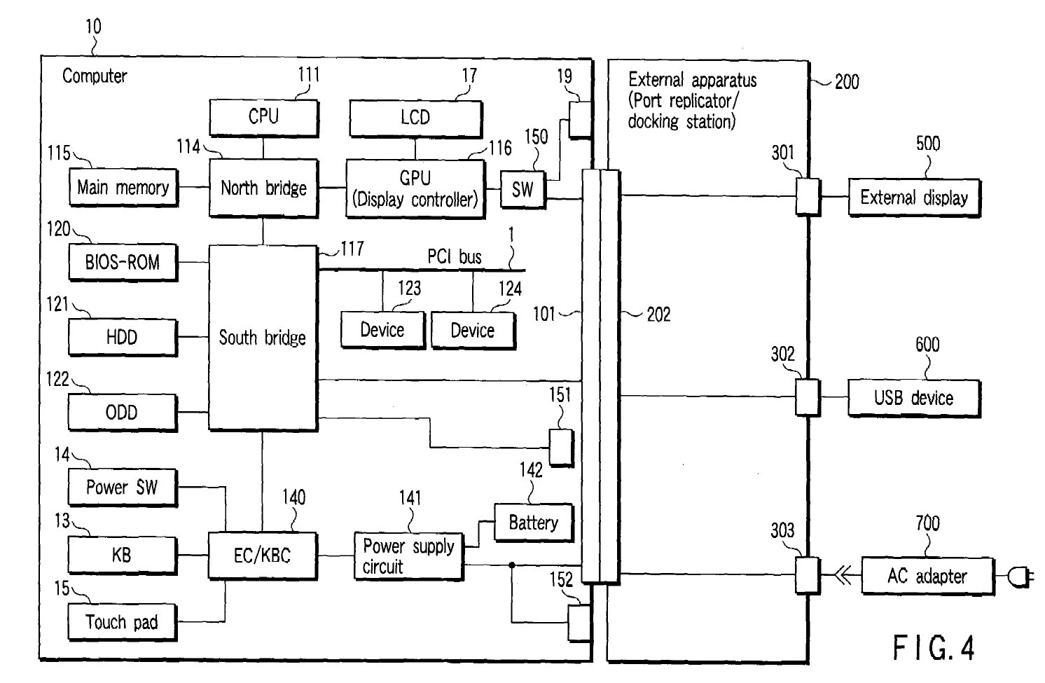

Next, referring to FIG. 4, the system configuration of the computer 10 is described.

As shown in FIG. 4, the computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, various PCI devices 123 and 124, an embedded controller/keyboard controller IC (EC/KBC) 140, and a power supply circuit 141.

The CPU 111 is a processor that controls the operation of the computer 10. The CPU 111 executes an operating system and various application programs, which are loaded from the HDD 121 into the main memory 115. The CPU 111 also executes a BIOS (Basic Input/Output System) that is stored in the BIOS-ROM 120. The BIOS is a program for hardware control.

The north bridge 114 is a bridge device that connects a local bus of the CPU 111 and the south bridge 117. The north bridge 114 includes a memory controller which access-controls the main memory 115. The north bridge 114 has a function of executing communication with the graphics processing unit (GPU) 116 via, e.g. a PCI Express bus.

The graphics processing unit (GPU) 116 is a display controller which controls the LCD 17 that is used as a display monitor of the computer 10, and a display device which is connected to the video signal output terminal 19 provided on the computer main body 11 or to the video signal output terminal 301 provided on the external apparatus 200. In the description below, the display device, which is connected to the video signal output terminal 19 or the video signal output terminal 301, is referred to as “external display device”.

The GPU 116 has an output terminal for outputting a video signal which is to be supplied to the external display device, and this output terminal is connected to the video signal output terminal 19 via a switch circuit (SW) 150. In the state (docking state) in which the computer 10 is connected to the external apparatus 200, that is, in the state in which a docking connector 101 provided on the computer main body 11 is connected to the docking connector 202 provided on the external apparatus 200, the output terminal of the GPU 116 is connected to the video signal output terminal 301 via the switch circuit (SW) 150, docking connectors 101 and 202 and a signal line within the external apparatus 200.

The switch circuit (SW) 150 is realized by an analog switch, and outputs a video signal from the GPU 116 to one of the video signal output terminal 19 and video signal output terminal 301. Specifically, in the state (undocking state) in which the computer 10 is not connected to the external apparatus 200, the switch circuit (SW) 150 connects the output terminal of the GPU 116 to the video signal output terminal 19. Thereby, the video signal from the GPU 116 is supplied to the video signal output terminal 19. On the other hand, in the docking state, the switch circuit (SW) 150 connects the output terminal of the GPU 116 to the video signal output terminal 301 via the docking connectors 101 and 102 and the signal line within the external apparatus 200. Thereby, the video signal from the GPU 116 is supplied to the video signal output terminal 301. If an external display device 500 is connected to the video signal output terminal 301, as shown in FIG. 4, the video signal from the GPU 116 is sent to the external display device 500.

The wiring length between the output terminal of the GPU 116 and the video signal output terminal 301 is greater than the wiring length between the output terminal of the GPU 116 and the video signal output terminal 19. In addition, the docking connectors 101 and 202 intervene between the output terminal of the GPU 116 and the video signal output terminal 301. Consequently, the attenuation of the video signal becomes greater in the case where the video signal is supplied to the video signal output terminal 301 than in the case where the video signal is supplied to the video signal output terminal 19.

In the computer 10, the GPU 116 is configured to output video signals of different amplitudes between the undocking state and the docking state. In other words, the GPU 116 switches the amplitude of the video signal in response to docking/undocking. In the undocking state, the GPU 116 outputs a video signal with a first amplitude in order to display image data on the external display device connected to the video signal output terminal 19. If the computer 10 is docked on the external apparatus 200, the GPU 116 changes the amplitude of the video signal to a second amplitude which is greater than the first amplitude, in order to display image data on the external display device 500 connected to the video signal output terminal 301.

The first amplitude is preset in accordance with the wiring length between the GPU 116 and the video signal output terminal 19, and the second amplitude is preset in accordance with the wiring length between the GPU 116 and the video signal output terminal 301.

As mentioned above, one of the video signal output terminal 19 and video signal output terminal 301 is exclusively used. Thus, the GPU 116 switches the amplitude of the video signal in response to the docking/undocking, and thereby the GPU 116 can supply to the external display device a video signal having a predetermined amplitude (e.g. 700 mV ±5%) conforming technical standards, no matter whether the computer 10 is in the undocking state or in the docking state. Specifically, in the undocking state, the GPU 116 can output a video signal having a predetermined amplitude conforming to the technical standard to the video signal output terminal 19. In addition, in the docking state, the GPU 116 can output a video signal having a predetermined amplitude conforming to the technical standard to the video signal output terminal 301.

The south bridge 117 is connected to a PCI bus 1, and executes communication with PCI devices 123 and 124 via the PCI bus 1. In addition, the south bridge 117 includes an IDE (Integrated Drive Electronics) controller and a Serial ATA controller for controlling the hard disk drive (HDD) 121 and optical disc drive (ODD) 122. Further, the south bridge 117 includes a function of controlling a USB device which is connected to a USB port 151 provided on the computer main body 11, and a USB device 600 which is connected to a USB port 302 provided on the external apparatus 200.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 has a function of powering on/off the computer 10 in response to the user's operation of the power button switch 14. The power-on/power-off control of the computer 10 is executed by a cooperation of the EC/KBC 140 and the power supply circuit 141. The power supply circuit 141 generates operation power, which is to be supplied to the components of the computer 10, using power from a battery 142 mounted in the computer main body 11, power from an AC adapter which is connected as an external power supply to an external power supply terminal 152 provided on the computer main body 11, or power from an AC adapter 700 which is connected as an external power supply to an external power supply terminal 303 provided on the external apparatus 200.

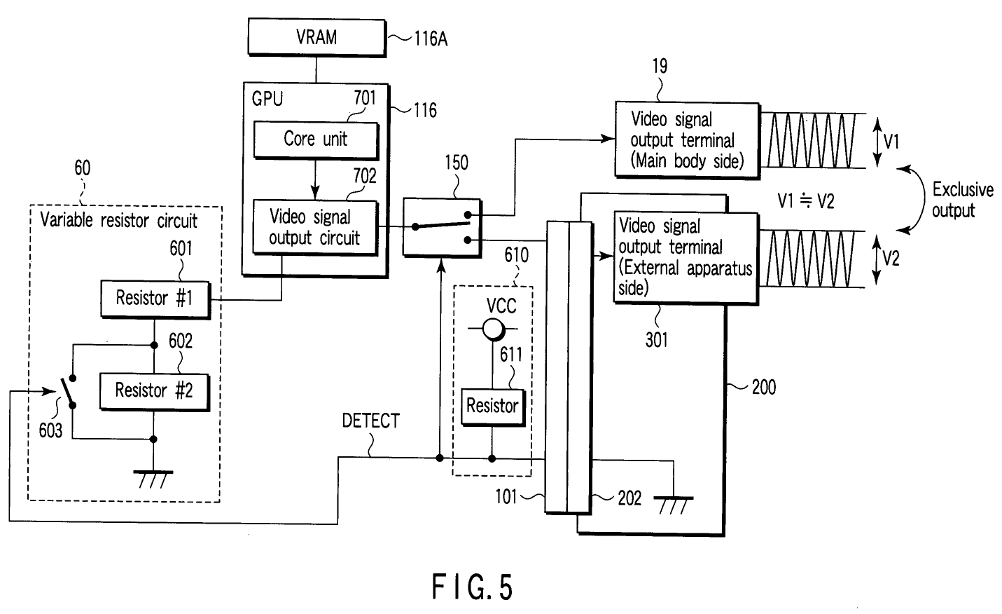

Next, referring to FIG. 5, an example of the specific structures of the GPU 116 and its peripheral circuits is described.

The computer main body 11 includes a detection unit 610 for detecting whether the computer main body 11 is connected to the external apparatus 200. The detection unit 610 includes a passive component 611, such as pull-up resistor for example, which is connected between a docking detection signal (DETECT) line and a power supply terminal VCC. In the external apparatus 200, a pin within the docking connector 202, which is connected to the docking detection signal (DETECT) line, is grounded.

In the case where the computer main body 11 is not connected to the external apparatus 200, the detection unit 610 outputs a docking detection signal (DETECT) of “1”. In the case where the computer main body 11 is connected to the external apparatus 200, the detection unit 610 outputs a docking detection signal (DETECT) of “0”.

The docking detection signal (DETECT) is sent to the switch circuit 150. When the docking detection signal (DETECT) is “1”, the switch circuit 150 connects the output terminal of the GPU 116 to the video signal output terminal 19. On the other hand, when the docking detection signal (DETECT) is “0”, the switch circuit 150 connects the output terminal of the GPU 116 to the video signal output terminal 301 of the external apparatus 200 via the docking connectors 101 and 202.

The GPU 116 is configured to change the amplitude of the video signal in accordance with the value of the resistance that is connected to the GPU 116. Specifically, the amplitude value of the video signal, which is output from the GPU 116, is determined by the resistance value of the external resistor that is connected to the GPU 116.

In this embodiment, a variable resistor circuit 60 is used as the external resistor. The variable resistor circuit 60 varies the resistance value of the resistor connected to the GPU 116 in accordance with the detection result by the detection unit 610. The variable resistor circuit 60 comprises two series-connected resistors 601 and 602 and a switch circuit 603 which is connected in parallel to the resistor 602. The switch circuit 603 is on/off controlled by the docking detection signal (DETECT).

The amplitude value of the video signal, which is output from the GPU 116, is proportional to the value of the current that flows in the variable resistor circuit 60.

When the docking detection signal (DETECT) is “1” (undocking state), the switch circuit 603 is turned off. Thereby, a current of the first value flows in the variable resistor circuit 60. On the other hand, when the docking detection signal (DETECT) is “0” (docking state), the switch circuit 603 is turned on. Thereby, a current of the second value that is greater than the first value flows in the variable resistor circuit 60. Accordingly, in the docking state, the amplitude value of the video signal that is output from the GPU 116 is greater than in the undocking state.

The GPU 116 includes a core unit 701 and a video signal output circuit 702. The core unit 701 generates a video signal from display data which is written in a VRAM 116A by the CPU 111. The video signal output circuit 702 alters the amplitude value of the video signal to be output, in accordance with the resistance value of the variable resistor circuit 60. In the undocking state (the switch 603 is in the off-state), the video signal output circuit 702 outputs the video signal of the first amplitude. In the docking state (the switch 603 is in the on-state), the video signal output circuit 702 outputs the video signal of the second amplitude that is greater than the first amplitude. Thus, an amplitude V1 of the video signal appearing at the video signal output terminal 19 in the undocking state is equal to an amplitude V2 of the video signal appearing at the video signal output terminal 301 in the docking state. Each of the amplitudes V1 and V2 can meet the requirement of the amplitude value (e.g. 700 mV ±5%) specified by the technical standards.

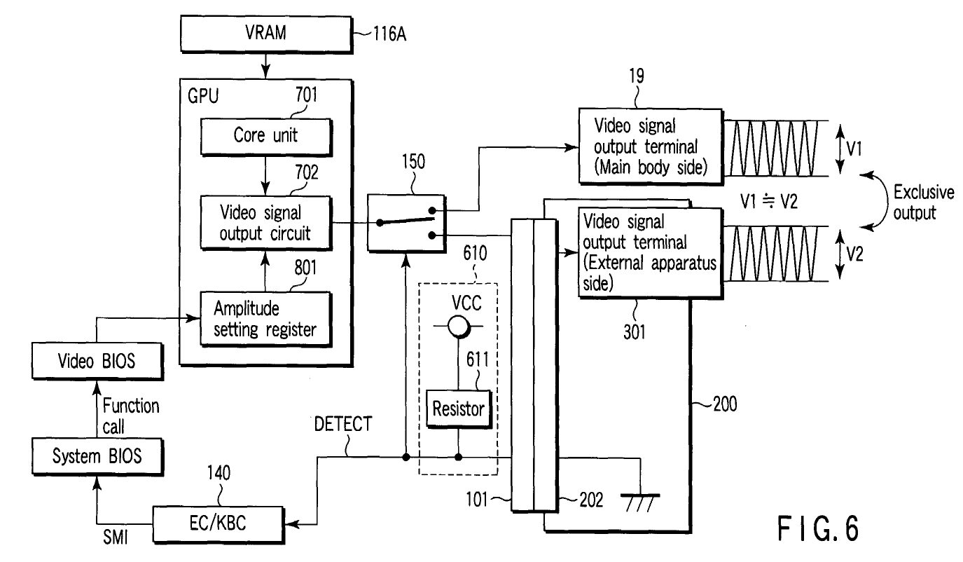

Next, referring to FIG. 6, another example of the specific structures of the GPU 116 and its peripheral circuits is described.

In FIG. 6, the GPU 116 includes an amplitude setting register 801 in which a control parameter for designating the amplitude of the video signal is set. The video signal output circuit 702 of the GPU 116 changes the amplitude of the video signal in accordance with the value of the control parameter that is set in the amplitude setting register 801.

The EC/KBC 140 detects a variation in logic level of the docking detection signal (DETECT) and outputs an interrupt signal (e.g. system management interrupt SMI) to the CPU 111, thereby informing software, such as the BIOS for example, of the current logic level. The BIOS informs a video BIOS of the occurrence of a docking event or the occurrence of an undocking event in accordance with the logic level reported from the EC/KBC 140. If the video BIOS is informed of the occurrence of the docking event, the video BIOS sets in the amplitude setting register 801 a control parameter designating the second amplitude. If the video BIOS is informed of the occurrence of the undocking event, the video BIOS sets in the amplitude setting register 801 a control parameter designating the first amplitude.

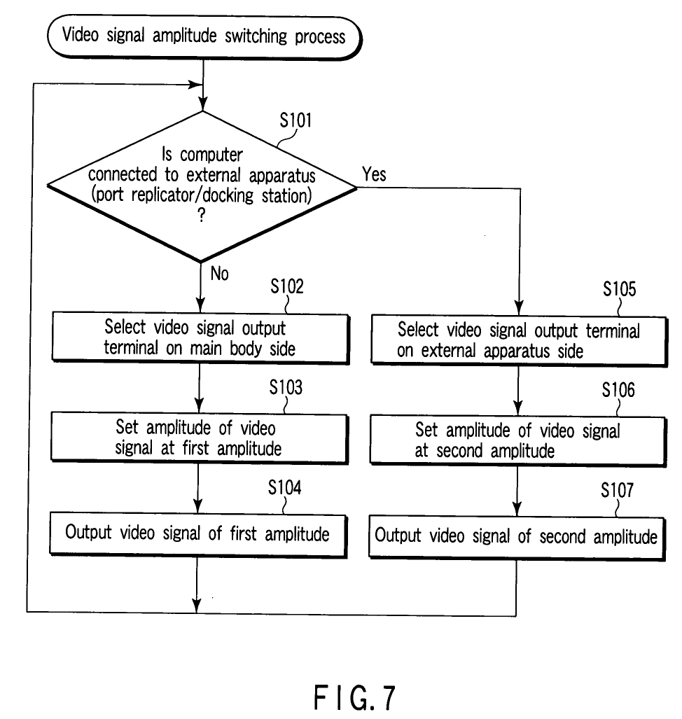

Next, with reference to a flow chart of FIG. 7, a description is given of an example of the procedure of a video signal amplitude switching process which is executed by the computer 10.

To begin with, the detection unit 610 determines whether the computer 10 is connected to the external apparatus 200.

If the computer 10 is not connected to the external apparatus 200 (NO in block S101), the video signal output terminal 19 of the computer main body 11 is selected by the switch circuit 150, and the output terminal of the GPU 116 is connected to the video signal output terminal 19 (block S102). A process of setting the amplitude of the video signal, which is to be output from the GPU 116, at the first amplitude is executed by changing the resistance value of the variable resistor circuit 60 or by setting the control parameter in the amplitude setting register 801 (block S103). The GPU 116 outputs the video signal of the first amplitude in accordance with the resistance value of the variable resistor circuit 60 or the control parameter set in the amplitude setting register 801 (block S104).

If the computer 10 is connected to the external apparatus 200 (YES in block S101), the video signal output terminal 301 of the external apparatus 200 is selected by the switch circuit 150, and the output terminal of the GPU 116 is connected to the video signal output terminal 301 of the external apparatus 200 (block S105). A process of setting the amplitude of the video signal, which is to be output from the GPU 116, at the second amplitude is executed by changing the resistance value of the variable resistor circuit 60 or by setting the control parameter in the amplitude setting register 801 (block S106). The GPU 116 outputs the video signal of the second amplitude in accordance with the resistance value of the variable resistor circuit 60 or the control parameter set in the amplitude setting register 801 (block S107).

As has been described above, in the present embodiment, the amplitude of the video signal, which is output from the GPU 116, is automatically adjusted in accordance with the detection result of docking/undocking. Therefore, no matter whether the video signal is to be output to the video signal output terminal 19 of the computer main body 11 or to the video signal output terminal 301 of the external apparatus 200, the video signal with the amplitude conforming to technical standards can be supplied to the external display.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body adapted for coupling to an external apparatus;
a detection unit provided in the main body, the detection unit to detect whether the main body is coupled to the external apparatus; and
a display controller provided in the main body, the display controller to change an amplitude of the video signal from a first amplitude to a second amplitude different from the first amplitude when the detection unit detects that the main body is connected to the external apparatus.

2. The information processing apparatus according to claim 1, wherein the display controller to output the video signal having the second amplitude to display image data on a display device connected to a first video signal output terminal provided on the external apparatus, and to output the video signal data having the first amplitude for display of the image data on the display device connected to a second video signal output terminal provided on the main body.

3. The information processing apparatus according to claim 1, wherein the first amplitude is determined in accordance with a wiring length between the display controller and the second video signal output terminal.

4. The information processing apparatus according to claim 3, wherein the second amplitude is determined in accordance with a wiring length between the display controller and the first video signal output terminal of the external apparatus.

5. The information processing apparatus according to claim 1, wherein the display controller includes a video signal output circuit to change an amplitude of the video signal in accordance with a value of a resistance connected to the display controller.

6. The information processing apparatus according to claim 5, further comprises a variable resistor circuit provided in the main body and varies the value of the resistance connected to the display controller in accordance with a detection result by the detection unit.

7. The information processing apparatus according to claim 1, wherein the display controller comprises
a register including a control parameter for designating the amplitude of the video signal; and
a video signal output circuit to change the amplitude of the video signal in accordance with the control parameter set in the register.

8. The information processing apparatus according to claim 1, wherein the information processing apparatus further comprises software adapted to (i) set a first controller parameter within the register to designate the first amplitude when the detection unit detects that the main body is not connected to the external apparatus, and (ii) set in the register a second control parameter to designate the second amplitude when the detection unit detects that the main body is connected to the external apparatus.

9. The information processing apparatus according to claim 2, further comprising a switch circuit provided in the main body, the switch circuit to connect an output of the display controller to the second video signal output terminal when the detection unit detects that the main body is not connected to the external apparatus, and to connect the output of the display controller to the first video signal output terminal when the detection unit detects that the main body is connected to the external apparatus.

10. An information processing apparatus, comprising:
a main body including (i) a first video signal output terminal adapted for coupling the main body to an external apparatus and (ii) a second video signal output terminal adapted for coupling the main body to a display device;
a detection unit to detect whether the main body is coupled to the external apparatus;
a display controller provided in the main body, the display controller to output a video signal having a first amplitude when the detection unit detects that the main body is not coupled to the external apparatus, and to output the video signal having a second amplitude greater than the first amplitude when the detection unit detects that the main body is coupled to the external apparatus; and
a switch circuit provided in the main body, the switch circuit to couple an output of the display controller to the second video signal output terminal when the detection unit detects that the main body is not connected to the external apparatus, and to connect the output of the display controller to the first video signal output terminal via the external apparatus when the detection unit detects that the main body is connected to the external apparatus.

11. The information processing apparatus according to claim 10, wherein the display controller includes a video signal output circuit to change an amplitude of the video signal from the first amplitude to the second amplitude in accordance with a value of a resistance coupled to the display controller.

12. The information processing apparatus according to claim 11, further comprises a variable resistor circuit provided in the main body, the variable resistor circuit varies the value of the resistance connected to the display controller in accordance with a detection result by the detection unit.

13. The information processing apparatus according to claim 10, wherein the display controller includes a register in which a control parameter for designating that an amplitude of the video signal is set, and a video signal output circuit to change the amplitude of the video signal in accordance with the control parameter set in the register.

14. The information processing apparatus according to claim 13, further comprises software to set a first control parameter in the register to designate the first amplitude when the detection unit detects that the main body is not connected to the external apparatus, and to set a second control parameter in the register to designate the second amplitude when the detection unit detects that the main body is connected to the external apparatus.

15. A video signal amplitude control method for controlling an amplitude of a video signal output from a display controller provided in an information processing apparatus adapted for coupling to an external apparatus having a first video signal output terminal to which a display device is connectable, comprising:
determining whether the information processing apparatus is connected to the external apparatus;
setting the amplitude of the video signal output from the display controller to a first amplitude; and
changing the amplitude of the video signal output from the display controller to a second amplitude greater than the first amplitude when the information processing apparatus is connected to the external apparatus, thereby to display image data on the display device connected to the first video signal output terminal.

16. The video signal amplitude control method according to claim 15, wherein the display controller includes a video signal output circuit to change the amplitude of the video signal in accordance with a value of a resistance connected to the display controller.

17. The video signal amplitude control method according to claim 16, wherein the setting of the amplitude of the video signal to the first amplitude includes setting the value of the resistance to a first resistance value corresponding to the first amplitude when the information processing apparatus is not connected to the external apparatus.

18. The video signal amplitude control method according to claim 17, wherein the changing of the amplitude of the video signal at the second amplitude includes changing the value of the resistance to a second resistance value corresponding to the second amplitude when the information processing apparatus is connected to the external apparatus.

19. The video signal amplitude control method according to claim 15, wherein the setting of the amplitude of the video signal to the first amplitude includes storing a first control parameter in the register to designate the first amplitude when the information processing apparatus is not connected to the external apparatus.

20. The video signal amplitude control method according to claim 19, wherein the changing of the amplitude of the video signal includes changing the amplitude of the video signal to the second amplitude by storing a second control parameter in the register to designate the second amplitude when the information processing apparatus is connected to the external apparatus.
